(19) United States
(12) Patent Application Publication
(10) Pub. No.: US 2026/0143278 A1
(43) Pub. Date: May 21, 2026

(54) DIRECTIONAL SOUND FOR A VEHICLE

(71) Applicant: Ford Global Technologies, LLC, Dearborn, MI (US)

(72) Inventors: Ranjani Rangarajan, Farmington Hills, MI (US); Diana Delgado Burrola, El Paso, TX (US)

(73) Assignee: Ford Global Technologies, LLC, Dearborn, MI (US)

(21) Appl. No.: 18/951,878

(22) Filed: Nov. 19, 2024

(51) Int. Cl. H04R 1/32; B60R 1/23; B60R 11/02; G06V 40/10; H04R 1/22

(52) U.S. Cl. CPC H04R 1/323; B60R 1/23; B60R 11/0217; G06V 40/10; H04R 1/22; H04R 2499/13

(57) ABSTRACT

A vehicle may output ultrasonic sound from a speaker that is supported by a moveable surface mounted in an interior of a vehicle, detect an object within a threshold distance of the vehicle, determine a trajectory of the object, and based on the trajectory of the object actuate the moveable surface to direct the ultrasonic audio based on the trajectory of the object.

### BACKGROUND

Vehicles typically include sensors for collecting data about the vehicle and/or an environment around the vehicle. In some examples, sensor data can be used by vehicle systems to actuate vehicle components based on data about objects around the vehicle. Vehicles can also include speakers to output sound. For example, vehicle speakers may output sound for an occupant's telephone call or the like.

### BRIEF DESCRIPTION OF THE DRAWINGS

FIG. 1 is a block diagram of an example vehicle system.

FIG. 2 illustrates an example vehicle with directional sound.

FIG. 3 illustrates an example apparatus for directing sound output.

FIG. 4 is a process flow diagram illustrating an example process for actuating vehicle components based on objects proximate to the vehicle.

FIG. 5 is a process flow diagram illustrating an example process for determining a sound output zone.

### DETAILED DESCRIPTION

### Introduction

Described herein are techniques for controlling output of sound from vehicle speakers based on detecting and interacting with objects within a specified distance of a vehicle. A vehicle computer may classify an object and determine a trajectory of the object based on data collected by vehicle sensors. The vehicle may then actuate components based on the classification and trajectory of the object, including outputting ultrasonic sound to produce a directional sound audible by a vehicle user but not audible at a location of the object.

Accordingly, included in the present disclosure is a system comprising a computer having a processor and a memory, the memory storing instructions executable by the processor to output ultrasonic audio from a speaker that is supported by a moveable surface mounted in an interior of a vehicle, detect an object within a threshold distance of the vehicle, determine a trajectory of the object, and based on the trajectory of the object, actuate the moveable surface to direct the ultrasonic audio based on the trajectory of the object.

Actuating the moveable surface may include directing an axis of the ultrasonic audio away from the trajectory of the object.

The ultrasonic audio may include a first sound output having a first frequency and a second sound output having a second frequency, the first sound output and second sound output producing a third sound output having a third frequency.

The moveable surface may be a first link member supported by a second link member, the speaker being supported by the first link member.

The moveable surface may be supported by a rear-view mirror.

Based on detecting a second object, respective priorities may be assigned to the object and the second object.

The moveable surface may be actuated to direct a direction of the ultrasonic audio away from the trajectory of the object having a highest priority.

The moveable surface may be actuated to direct a direction of the ultrasonic audio away from the trajectory of all objects.

The priorities may be assigned based on relative proximity to the vehicle.

The priorities may be assigned based on relative speeds of the objects.

The priorities may be assigned based on relative trajectories of the objects.

A method comprises outputting ultrasonic audio from a speaker that is supported by a moveable surface mounted in an interior of a vehicle, detecting an object within a threshold distance of the vehicle, determining a trajectory of the object, and based on the trajectory of the object, actuating the moveable surface to direct the ultrasonic audio based on the trajectory of the object.

Actuating the moveable surface may include directing an axis of the ultrasonic audio away from the trajectory of the object.

The ultrasonic audio may include a first sound output having a first frequency and a second sound output having a second frequency, the first sound output and second sound output interfering to produce a third sound output having a third frequency.

Based on detecting a second object, respective priorities may be assigned to the object and the second object.

The moveable surface may be actuated to direct a direction of the ultrasonic audio away from the trajectory of the object having a highest priority.

The moveable surface may be actuated to direct a direction of the ultrasonic audio away from the trajectory of all objects.

The priorities may be assigned based on relative proximity to the vehicle.

The priorities may be assigned based on relative speeds of the objects.

The priorities may be assigned based on relative trajectories of the objects.

### Exemplary System Elements

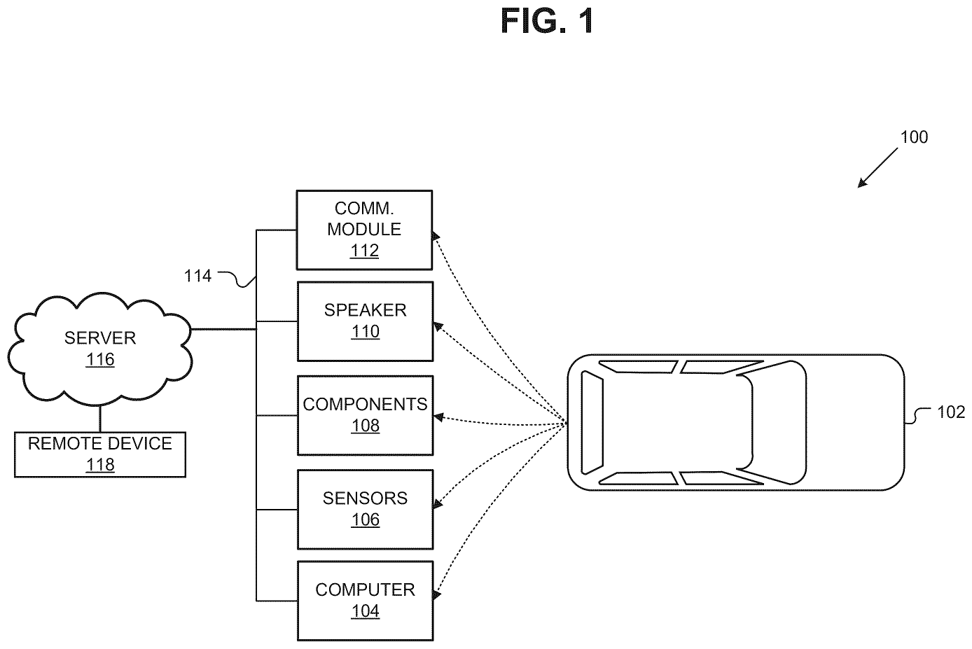

FIG. 1 is a block diagram of a vehicle system 100. The vehicle 102 may be any passenger or commercial automobile such as a car, a truck, a sport utility vehicle, a crossover, a van, a minivan, a taxi, a bus, ICE (Internal Combustion Engine), BEV (Battery Electric Vehicle), hybrid, a PHEV (Plug-in Hybrid Electric Vehicle), etc. The vehicle 102 includes a computer 104, sensors 106, components 108, one or more sound output device such as a speaker 110, a communication module 112, and a communications network 114.

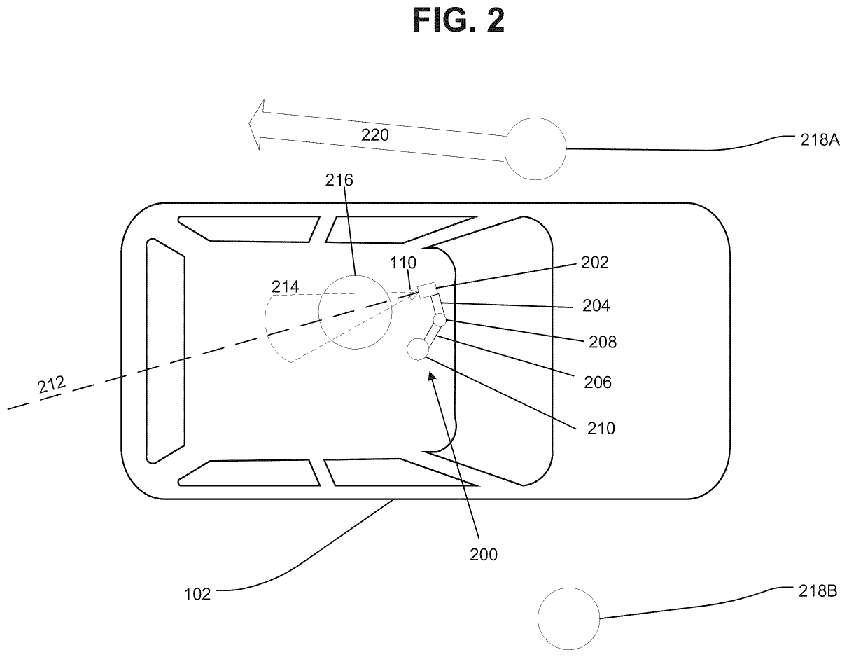

The vehicle 102 includes the computer 104 having a memory that includes instructions executable by a processor of the computer 104 to carry out processes and operations including as described herein. For example, the memory stores instructions executable by the processor, including instructions to actuate vehicle components including an arm 200 (see FIG. 2) and a speaker 110 based on a trajectory of an object around the vehicle 102.

The memory of the vehicle computer 104 includes one or more forms of computer readable media, and stores instructions executable by the computer 104 for performing various operations, including as disclosed herein. For example, the computer 104 can be a generic computer with a processor and memory as described above and/or may include an electronic control unit (ECU) or controller for a specific function or set of functions, and/or a dedicated electronic circuit including an application specific integrated circuit (ASIC) that is manufactured for a particular operation (e.g., an ASIC for processing sensor data and/or communicating the sensor data). In another example, the computer 104 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). In some examples, a combination of processor(s), ASIC(s), and/or FPGA circuits may be included in a computer 104. The computer 104 may be embodied as multiple computers coupled together.

The memory can be of any type (e.g., hard disk drives, solid state drives, servers, or any volatile or non-volatile media). The memory can store the collected data sent from the sensors 106. The memory can be a separate device from the computer 104, and the computer 104 can retrieve data stored by the memory via the communications network 114 in the vehicle 102 (e.g., over a CAN bus, a wireless network, etc.) Alternatively or additionally, the memory can be part of the computer 104 (e.g., as a memory of the computer 104).

The computer 104 may be communicatively coupled via the communication network 114 with the sensors 106, the components 108, an arm 200 (see FIG. 2), speakers 110, and the communication module 112 in the vehicle 102. The computer 104 is generally arranged for communications on the communication network 114 that can include a bus in the vehicle 102 such as a controller area network CAN or the like, and/or other wired and/or wireless mechanisms. Alternatively or additionally, in cases where the computer 104 actually comprises a plurality of devices, the communication network 114 may be used for communications between devices represented as the computer 104 in this disclosure. Further, as mentioned below, various controllers and/or sensors such as the camera may provide data to the computer 104 via the communication network 114.

The vehicle 102 typically includes a variety of sensors 106. A sensor 106 is a device that can obtain one or more measurements of one or more physical phenomena. Some sensors 106 detect internal states of the vehicle 102, for example, wheel speed, wheel orientation, and engine and transmission variables. Some sensors 106 detect the location and/or orientation of the vehicle 102, for example, global positioning system GPS sensors. Some sensors 106 detect objects, for example, radar sensors, scanning laser range finders, light detection and ranging LIDAR devices, and image processing sensors such as cameras. Further sensors 106 detect sounds, for example dynamic or condenser microphones, piezoelectric transducers, ultrasonic sensors, acoustic emission sensors, etc. Such sensors for detecting sound are herein referred to as audio sensors. Audio sensors detect sound waves by measuring vibrations and converting them to electrical signals.

A sensor 106 may be positioned in or on the vehicle 102 to provide a field of view extending outwards relative to the vehicle body. The field of view can be determined by specifications of the camera (e.g., a viewing angle providing by the camera) and pose or orientation of the camera (e.g., a pitch, roll, and yaw of an axis of the camera lens relative to a horizontal plane of the vehicle 102). The field of view is referred to as fixed or static when the camera is installed such that its pose cannot be changed. Additionally or alternatively, the camera may be moveably supported by the vehicle 102 and actuatable by the vehicle computer 104 such that the camera pose and/or a focus or orientation of a lens can be changed, and field of view thereby dynamically adjusted.

The vehicle 102 may include one or more speakers 110. The computer 104 may actuate a speaker 110 to output sound. A speaker 110 can be any suitable device configured to output sound (i.e., pressure waves that are transmitted or propagated through a medium such as air), including possibly to occupants of the vehicle 102. A speaker 110 could output sound based on a user telephone call, a user playing a podcast, a vehicle radio, a vehicle computer 104 for providing audible messages to occupants, etc.

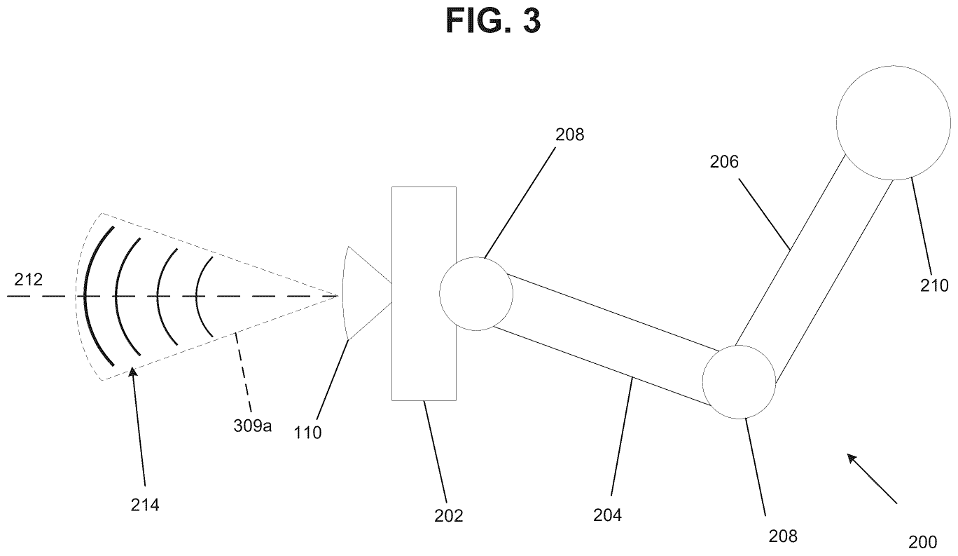

As seen in FIGS. 2 and 3, a speaker 110 can be mounted to a platform 202 and be in communication with the computer 104. A speaker 110 is a transducer that can convert electrical audio signals to sound waves. The computer 104 can command the speaker 110 to output sound so that the speaker 110 outputs audio for a vehicle occupant. The 110 platform 202 may be formed of any suitable materials, such as a plastic or metal.

A speaker 110 may output sound having a frequency too high to be audible to the human car (e.g., ultrasonic sound), taking advantage of the fact that ultrasonic sound waves have minimal side lobes, that is, can have their dispersion limited to a desired direction. Ultrasonic sound is output of sound waves with a frequency beyond the range of frequencies audible to the human car (e.g., greater than 20,000 Hz). The computer 104 can use a suitable technique to render the ultrasound output audible to the human car, that is, speaker 110 may output ultrasonic sound that is made audible (i.e., detectable by a typical occupant) to vehicle occupants by modulation. Modulation is the process of varying one or more properties (e.g., frequency or amplitude) of a sound wave (i.e., the carrier signal) with a separate signal (i.e., the modulation signal) which includes information to be transmitted. When the sound wave is demodulated the information is extracted from the carrier signal. Ultrasonic sound waves, for example, demodulate by travelling through air (e.g., self-demodulation) as a result of the nonlinear mixing of high-frequency waves.

The computer 104 may include programming to operate one or more of vehicle components 108 such as propulsion (e.g., control of speed in the vehicle 102 by controlling one or more of an internal combustion engine, electric motor, hybrid engine, etc.), steering, interior and/or exterior lights, the speakers 110, the arm 200 supporting the speakers 110, etc.

FIG. 2 illustrates a pivotable arm system 200 including a speaker 110 outputs that outputs sound 214 to a vehicle occupant in a sound output zone 214. The computer 104 may determine the orientation of the speaker 110 as described in further detail below, based on a desired direction of sound, defined by an axis 212 of the sound output zone 214, which describes a volume in which sound is dispersed, that is, is expected to be audible to a human user. The sound output zone 214 can be determined according to a location of a user head 216, a direction of the axis 212 (determined based on the location of the user head 216), and a frequency, distance, and amplitude of output sound waves. The axis 212 has an endpoint or origin at a location in or on the speaker 110 (i.e., a location from which the sound output of the speaker 110 emanates), and is defined to provide a shortest distance from the speaker 110 to the occupant head 216. The sound output zone 214 is represented as a volume (or space) taking the general shape of a cone due to the natural dispersion of sound through media (i.e., as sound waves propagate through mediums, the dispersion of, or put another way, the cross-section of area intersected by, the waves increase with distance and the sound level or intensity decreases). The axis 212 indicates the direction of the sound 214, typically in a three-dimensional Cartesian coordinate system defined with respect to the interior of a vehicle 102.

Upon determining a desired sound output zone 214 based on a location of an operator head 216 and a sound intensity to be received by the operator, the computer 104 may then determine an orientation of the platform 202 and respective angles of members 204, 206 of the arm 200 to achieve that orientation so as to provide a sound output zone 214 for sound from the speaker 110 that intersects the vehicle occupant but avoids intersecting the object 218. In other words, the computer 104 may determine an orientation of the speaker 110 such that the sound waves output by the speaker 110 travel towards and intersect the occupant. For example, the computer 104 may actuate the arm 200 such that the axis 212 passes through a head 216 of the occupant (e.g., a point between the eyes of the occupant).

Ultrasonic sound waves may be represented as having a “near field” and a “far field.” The near field is the portion of the sound output zone 214 in which the sound waves propagate extending from the speaker 110 to a point referred to as the “last maximum.” The last maximum is the point at which the sound level (e.g., the decibel level) of the sound output 214 begins to decrease as will be discussed in further detail below. The far field is the portion of the sound output zone 214 after the last maximum in which the sound waves propagate until reaching a sound level of zero (i.e., until dissipating fully).

The computer 104 may detect an object 218 proximate to the vehicle 102 (i.e., within range of sensors 106 of the vehicle 102) and determine the trajectory 220 of the object 218 based on sensor data using any suitable object detection technique to interpret data from the sensors 106 as described in further detail below. The computer 104 may actuate a moveable arm 200 to move (i.e., linearly and/or rotationally with respect to a coordinate system as described above) the speaker 110 such that ultrasonic sound is directed towards a vehicle occupant as described herein. The object 218 may be any object or event detectable by the vehicle sensors 106. In various examples described herein, the object 218 is a person, though as further non-limiting examples the object 218 could be a second vehicle, an animal, etc.

The vehicle computer 104 may be programmed to detect and/or identify an object 218 within a threshold distance of the vehicle 102. That is, the computer 104 may store a threshold distance (e.g., 10 meters). The threshold distance may be prestored by the computer 104 and/or could be specified by user input. The computer 104 may determine that the object is within the threshold distance based on sensor data (e.g., image data, radar data, thermal data, etc.). The distance may be measured from a specified point or surface in or on the vehicle 102. The vehicle computer 104 may, for example, detect the object 218 and determine that the object 218 is within the threshold distance of the vehicle 102 (e.g., measured as a radius around a point defined in or on the vehicle 102, as a distance from an edge or surface of a vehicle 102 closest to an object 218 as defined by a vehicle body, from the sensor 106 which collected data about the object 218, or some other suitable reference) based on collected data about the object 218.

The vehicle computer 104 can make a determination of an object 218 being within the threshold distance of the vehicle 102 when it determines that the object 218 is detected within a distance of the vehicle 102 that is less than the threshold distance. Typically an object 218 is deemed to be within the threshold distance of the vehicle 102 if at least some surface or portion of the object 218 is detected within the threshold distance. 218

The threshold distance may be determined according to one or more factors. For example, the vehicle computer 104 may determine a threshold distance based on the vehicle 102 entering a geographic location (i.e., the vehicle computer 104 could store threshold distances for respective geographic areas, and could retrieve a threshold distance for a location from memory based on data from a location sensor, e.g., a GPS sensor). The threshold distance may be determined based on characteristics or attributes of a geographic location. For example, a higher threshold distance of 20 meters could be selected when in geographic locations where vehicles are less likely to be parked closely to one another (e.g., suburban residential neighborhoods or rural locations). On the other hand, a lower threshold distance of 10 meters could be selected where vehicles are likely to be parked more closely to one another (e.g., an urban location, a parking garage or parking lot, etc.). Alternatively or additionally, a threshold distance may be selected by a vehicle operator. As an example, if the vehicle operator desires the computer 104 to only detect objects which are close to the vehicle 102, the vehicle operator could set the threshold distance to 1 meter. The vehicle operator may select the threshold distance by any suitable means to provide input to the computer 104 (e.g., by interacting with a human machine interface). As a further example the computer 104 may adjust the threshold distance based on a determined status of the windows (e.g., is the window open more than a threshold amount or closed) Alternatively or additionally, computer 104 may start with a baseline threshold distance (e.g., 10 meters) and increase the distance by a specified amount per length that the window is open (e.g., for every 3 centimeters the window is rolled down, the computer 104 increases the threshold distance by 1 meter).

The specified distance may be measured from the vehicle 102 while the vehicle 102 is stationary or while the vehicle is in motion. The object 218 may be moving relative to the vehicle 102 while the vehicle is stationary or in motion and still be detected by the computer 104. As an example, the vehicle 102 may be backing down a driveway and an object 218 may be approaching towards the rear of the vehicle 102. The computer may then detect the object 218 within the threshold distance.

The vehicle computer 104 may be programmed to classify the object 218 based on image data from one or more vehicle sensors 106. Classifying the object 218 means determining a type or category of the object 218. For example, various techniques can be used to analyze data from cameras or other sensors 106 to determine a type or category of object 218. A type or category of object 218 means a kind of object, etc., a person, an animal, a vehicle, a rock, etc. Image data used for entity classification and/or other purposes (e.g., determining entity behavior such as direction and/or speed of movements) may be a plurality of images collected at different times. For example, analyzing a plurality of images collected at different times may allow the vehicle computer 104 to determine if the object 218 is walking towards the vehicle 102 or waving their hand.

The classification may include any suitable technique for object classification. A vehicle computer 104 could analyze data collected about the object 218 using a machine learning program or a rules-based program and assign a confidence to the object 218 (typically a percentage that indicates an estimated likelihood, e.g., 90%, 99%, etc.) that the entity classification is correct. The classification for a specific object 218 may be selected from a plurality of stored classifications by the vehicle computer 104.

Based on the classification of the object 218, the computer 104 may actuate the arm 200 to direct the output of the speaker 110 away from the object 218. That is, when the computer 104 detects the object 218 and classifies the object as a triggering object the computer 104 may actuate the arm 200 in six degrees of freedom such that the speaker 110 outputs ultrasonic sound towards a vehicle occupant and not the object 218. A “triggering object” in this context is an object 218 with a classification stored in the computer 104 as warranting control of one or more moveable platforms 202 to prevent or mitigate human-detectable sound from reaching the object 218. Example triggering objects include a pedestrian or a second vehicle etc.

The computer 104 may calculate the sound output zone 214 based on the frequency and amplitude of the sound waves being output by the speaker 110. That is, the computer 104 may determine a desired output zone 214 and adjust one or more variables such as frequency, amplitude, etc. such that the sound output 214 conforms to the output zone 214. As frequency of sound waves increases and amplitude decreases, propagation distance also decreases. The computer 104 may determine the limit of propagation through air of the sound waves based on the frequency and amplitude of the sound waves to then determine the sound output zone 214. For example, the computer 104 may utilize equation 1 to compute a sound level Lₛ (i.e., a sound power level) (e.g., in decibels) for a speaker 110 to provide sound waves at a sound level L_{D} at a distance r from a speaker 110:

$${L}_{D} = {L}_{s} + 10 log ( 1 / ( 4 π {D}^{2} ) + 4 / R ) \qquad Equation 1$$

In Equation 1, Lᵣ is received sound level in decibels, Lₛ is sound level from the source speaker 110 in decibels, R is a room constant, and D is a distance from the sound source (e.g., measured in meters) such as the speaker 110 or the endpoint of the axis 212 is defined. For example, if the user selects a volume (i.e., amplitude) of the sound, the computer 104 may compensate for the decrease in sound wave amplitude past the last maximum in the audio output zone 214 by increasing the output level (e.g., decibel level) of the speaker 110 or adjusting the phase of the sound waves such that the waves interact constructively or destructively to increase or decrease amplitude. The computer 104 may, for example, utilize equation 2 to calculate the interference of sound waves with equal amplitudes and frequency:

$$x = 2 Acos ( ϕ / 2 ) cos ( f t + ϕ / 2 ) \qquad Equation 2$$

In equation 2, x is the resulting waveform after interference as presented on a two dimensional graph, A is the amplitude (e.g., in meters), f is the frequency in Hertz, t is time in seconds, and φ is the phase difference (e.g., in degrees).

In addition to calculating the sound level as per Equation 1, the computer 104 may select a frequency of the sound output to determine the audio output zone 214. That is, the computer 104 may determine a distance from the speaker 110 at which the sound level is zero (e.g., the last maximum before the far field of the sound output) and select a frequency of the sound output such that the last maximum of the sound output is at a specified distance between the speaker 110 and the head 216 of the occupant after defining the sound output zone 214. For example, the computer 104 may utilize Equation 3 (see below) given the distance to the head 216 of the occupant to compute the frequency (e.g., in Hz) of the sound output of the speaker 110 such that the last maximum of the sound output is 10 centimeters in front of the head 216 of the occupant when the computer 104 defines the sound output zone 214:

$${D}_{M} = {( 2 {r}_{s} )}^{2} / ( 4 ( v / f ) ) \qquad Equation 3$$

In equation 2, D_{M} is the distance from the speaker 110 to the last maximum in meters, rₛ is the radius of the speaker 110 in meters, v is the phase speed of the sound waves (e.g., 343 m/s) and f is the frequency of the sound output 214.

Furthermore, the computer 104 may calculate the propagation of the sound output to determine the volume of the sound output in the zone 214. For example, the computer 104 may utilize equation 3 to calculate the pressure of sound waves for each speaker 110 before defining the sound output zone 214 based on the propagation of the sound waves:

$$Δ L = Δ {L}_{max} sin ( ( 2 π / λ ) D ∓ 2 π f t + ϕ ) \qquad Equation 4$$

In equation 4, ΔL is the change in sound level measured in decibels, ΔLₘₐₓ is the maximum possible change in sound level in decibels, λ is the wavelength of the sound wave in meters, D is the distance to the point being measured in meters, f is frequency in Hz, t is the time in seconds, and φ is the initial phase.

The speaker 110 can be actuated to out sound at a first, ultrasonic, frequency and a second, audible frequency such that modulation results in a user in the sound out zone 214 hearing the sound. The frequency of the sound output may be any frequency above 20,000 Hz (ultrasonic sound) whereas the frequency of the second sound output may be any frequency above 20,000 Hz and also greater than or lower than the frequency so that the first sound output can be modulated with the second sound output to produce the audible sound output. For example, the first sound output 214a may have a frequency of 100,000 Hz whereas the second sound output 214b may have a frequency of 110,000 Hz such that, when the sound outputs demodulate, they produce the resulting third sound output which has a frequency of 10,000 Hz (i.e., a frequency less than 20,000 Hz that is typically audible to the human ear).

The computer 104 may determine a desired frequency of the third sound output and then determine the frequencies (e.g., in hertz) and corresponding waveforms of the first and second sound outputs. That is, via modulation, the computer 104 may determine a specific waveform of sound waves which will produce the third sound output based on the demodulation of the waves as they propagate from the speaker 110) based on the desired third frequency such that the third sound wave transmits the desired data (e.g., via demodulation). As an example, the computer 104 may utilize equation 5 to calculate the frequency of the first or second sound outputs based on the desired third frequency:

$${f}_{3} = {f}_{1} - {f}_{2} βcos ( 2 π {f}_{2} t ) \qquad Equation 5$$

In equation 5, f₁ is the frequency of the first sound output in Hertz, f₂ is the frequency of the second sound output in Hertz, f₃ is the frequency of the resulting third sound output in Hertz, B is the modulation index (e.g., the ratio of the frequencies of the first output and the second wave, and t is time in seconds.

The computer 104 may actuate the arm 200 to orient the speaker 110 so that the occupant, but not the object 218 (e.g., a pedestrian) hears the sound 214. That is, the computer 104 may actuate the arm 200 so that the axis 212 as drawn from the platforms 202 intersects a head 216 of the occupant and not the object 218. As discussed above, the computer 104 may compute the sound output zone 214 based on the frequency and amplitude of the sound waves such that the sound output 214 propagates only to a specified distance behind the vehicle occupant (e.g., based on the position of the last maximum) and around the axis 212 such that the occupant is able to hear the sound output 214 at a selected volume. The computer 104 may utilize the sound output zone 214 to determine an angle of the arm 200 so that the speaker 110 outputs sound 214 in the sound output zone 214 such that the occupant can hear the sound but an object 218 cannot.

The computer 104 may determine a trajectory of the object 218. That is, the computer 104 may determine a speed and direction of an object based on sensor data. The computer 104 may determine the trajectory of the object 218 by any suitable means. For example, a machine learning program such as a neural network could be trained using data collected about objects to classify objects (e.g., to distinguish persons from other objects based on camera sensor data). As another example, the computer 104 may determine a speed and heading of an object (or lack thereof for a stationary object) based on the location of the object 218 within a plurality of image frames acquired at a specified frame rate (e.g., the computer 104 may triangulate the location of the object 218). In addition to determining a current trajectory of the object 218 (e.g., based on current speed and direction) the computer 104 may predict a trajectory of the object 218. The computer 104 may predict the object's trajectory by any suitable means. For example, the computer 104 may utilize an algorithm such as a Kalman filter (e.g., an algorithm using sensor data captured over a specified time period including statistical noise to generate estimates of possible trajectories).

FIG. 3 illustrates the arm 200 including a speaker 110 supported by a moveable platform 202. A moveable platform 202 is a physical platform which the computer 104 may cause to be moved by one or more motors or the like, and on which the speaker 110 is supported. The moveable platform 202 may be moveable in four or six degrees of freedom (i.e., linearly with respect to x, y, and/or z axes and/or rotationally with respect to the x, y, and z axes, i.e., adjust pitch, roll, and/or yaw). The speaker 110 may be supported by a platform which is coupled via a pivotable joint 208 to a first link member 204, in turn coupled via a second pivotable joint 208 to a second link member 206. Thus, in this example, the moveable platform 202 is supported by a plurality of link members 204, 206 which, with one or more pivotable joints 208, are included in a pivotable arm 200.

The speaker 110 may be supported by the moveable platform 202 which is pivotably coupled to the first link member 204 via a suitable coupling mechanism such as pivotable joint 208 (e.g., a “wrist” of the pivotable arm 200). The pivotable joint may, for example, be a ball and socket joint, a condyloid joint, etc. A pivotable joint 208 may include a motor actuatable by the computer 104 to adjust one or more angles between link members 206 and an attachment surface 210 (e.g., a vehicle mirror), between link members 204, 206, and/or between the link member 204 and the moveable platform 202. The moveable platform 202 may be supported by any suitable surface of the vehicle 102. For example, the moveable platform 202 may be supported by an attachment surface 210 such as a vehicle mirror in the interior of the vehicle 102.

The computer 104 may determine an orientation (e.g., in four or six degrees of freedom) of the platform 202 supporting the speaker 110, the first link member 204, and second link member 206 such that the sound output from the speaker 110 is directed towards a vehicle occupant and not also directed towards the object 218. An “orientation” means a location in real space including coordinates on an x, y, and z axes as well as pitch, roll, and yaw relative to a specified coordinate system. For example, a three-dimensional Cartesian coordinate system could be defined for a vehicle 102 interior and/or for the vehicle and an environment around the vehicle. The computer 104 may determine the angles between the elements of the arm 200 by, for example, algorithms utilizing inverse kinematics. Reverse kinematics is the process of determining angles for joints based on a known end coordinates (e.g., the computer 104 knowing the location of the user and the sound output zone 214 may utilize reverse kinematics to determine the orientation of the arm 200).

The computer may actuate the arm 200 to direct the sound output zone 214 away from the object 218 based on the trajectory 220 of the object 218. That is, the computer 104 may actuate the arm 200 such that the sound output zone 214 of the speaker 110 intersects the vehicle occupant but not a person who is, or who is associated with (e.g., riding in or on), the object 218 at the object's current location, such that the sound output is unlikely to be heard by the person associated with the object 218 as the object continues on its trajectory 220. The computer 104 may, as described above, determine the axis 212 of the sound output by the speaker 110 and determine angles of the first link member 204 and the second link member 206 relative to each other such that the sound output zone 214 intersects the vehicle occupant but not the object 218 (e.g., so that the axis 212 defines a shortest distance from the speaker 110 to an occupant head 216). After determining the predicted trajectory 220 of the object 218, the computer 104 may actuate arm 200 such that the link members 204, 206 form angles which orient the speaker 110 to output sound 214 in a sound output zone 214 that will not intersect the object 218 at any point on the predicted trajectory.

Furthermore, the computer 104 may actuate the arm 200 to redirect or move the sound output zone 214 based on the trajectory 220 changing or the trajectory 220 being unavoidable by the sound (e.g., in a scenario where the object 218 passes behind the vehicle 102, and even if the sound is blocked or attenuated by a rear window, audible sound might still reach an object 218). In a scenario where the object 218 changes trajectory 220, the computer 104 may recompute the predicted trajectory 220 and actuate the arm 200 to orient or reorient the sound output zone 214. In a scenario where the trajectory 220 of the object 218 is such that the trajectory 220 and the sound output zone 214 will intersect, the computer 104 may actuate the arm 200 to change or move the sound output zone 214 so that it does not intersect or overlap the object 218 for a longest possible period of time as determined by the computer 104 according to the predicted trajectory 220 of the object 218. When the object 218 has progressed along the trajectory 220 such that the object 218 is in the axis 212 of the sound output zone 214, the computer 104 may actuate the arm 200 to redirect the sound output zone 214 on a new nonoverlapping axis 212 (e.g., the computer 104 may redirect the sound output zone 214 to intersect a location previously occupied by the object 218).

In a scenario where more than one object 218 is detected within the threshold distance, the computer 104 could assign respective priorities to a first object 218a and a second object 218b and, for example, redirect the sound output zone 214 away from the object 218a, 218b having the highest priority. As used herein, a “priority” is a ranking of objects 218 that indicates a relative weight or importance of the object 218 relative to one or more other objects 218 for the purpose of directing the sound output zone 214. The priority may be specified according to a numeric scale (e.g., on a scale from 1-100, an object 218 may have a priority of 50), with priority increasing as the numbers increase (e.g., priority 75 might be higher than priority 75). Objects 218 may be assigned a baseline or default priority. The baseline priorities may be stored in a lookup table or the like that is stored in a memory of the computer 104 and that is specified by an equipment manufacturer such as a vehicle manufacturer. Priorities may correspond to factors such as relative proximity to the vehicle 102, relative speeds of the objects 218, and relative trajectories of the objects 218 as will be described below.

As mentioned above, the vehicle computer 104 may be programmed to assign respective priorities to multiple objects 218. That is, if more than one object 218 is detected within the threshold distance, the computer 104 may determine respective sound output zones 214 for the objects 218. For example, if an object 218a is detected within the threshold distance on a first side of the vehicle 102, and a second object 218b is detected within the threshold distance on a second side of the vehicle 102 at the same time, the computer 104 may classify and assign respective priorities to the objects 218a, 218b. The computer 104 is typically programmed to prioritize a first object 218 over a second object 218 based on the first object being assigned a higher priority than the second object.

A priority or priorities of an object or objects 218 may be determined according to a rules-based algorithm. That is, when specified conditions are met, the computer 104 may increase or lower an object's priority from a baseline or default priority. A specified condition in the present context means a condition or phenomenon detectable by vehicle sensors 106 which, according to programming in the computer 104, can influence the priority of an object 218 (e.g., proximity to vehicle, speed, or trajectory of the objects 218). According to one or more detected conditions, the vehicle computer 104 may reduce or increase the object's priority (e.g., if the trajectory 220 of the object 218 reduces distance to the vehicle 102 and the trajectory 220 of the second object increases distance to the vehicle 102, the computer 104 may increase the priority of the first object 218 and reduce the priority of the second object.).

The computer 104 may actuate the moveable platform 202 to direct the sound output zone 214 away from all objects 218 where more than one object 218 is detected. That is, if possible (e.g., if all trajectories 220 considered simultaneously leave a nonoverlapping axis 212 for the sound output zone 214) the computer 104 may direct the sound output zone 214 such that it does not intersect any object nor does it overlap with any trajectory 220. Alternatively, or additionally, in a scenario where there is no possible axis 212 for the sound output zone 214 that does not overlap with at least one trajectory 220 while still passing through the vehicle occupant, the computer 104 may as described above, direct the sound output zone 214 on an axis 212 which maximizes a length of time when the sound output zone 214 does not intersect an object 218. Once at least one object 218 progresses on their trajectory 220 such that the sound output zone 214 intersects the object 218, the computer 104 may further redirect the sound output zone 214 to maximize a length of time when the sound output zone 214 will not intersect an object 218.

Priorities assigned to objects 218 based on relative proximity of the objects 218 to the vehicle 102 may be adjusted. For example, as an object 218 moves closer to the vehicle 102 than another object 218, the higher the computer 104 may raise the priority of the closer object 218 from the baseline priority. As an example, the computer 104 may assign an object 218 which is at the edge of the threshold distance the baseline priority (e.g., 1). If, for example, the threshold distance is 10 meters, the computer 104 may increase the priority of the object by 10 for every 1 meter closer to the vehicle 102 that the object 218 is located.

Further, the computer 104 may assign priorities to objects 218 based on relative speeds of the objects 218 to the vehicle 102. That is, the faster the object 218 is travelling, the lower the computer 104 may reduce the priority of the object 218 from the baseline priority (e.g., because a faster object 218 has less potential time to “eavesdrop” on the sound output zone 214). As an example, the computer 104 may assign an object 218 which is travelling at speeds greater than 15 mph the baseline priority (e.g., 1) and for every decrease of 1 mph in speed of the object 218, the computer 104 may increase the priority of the object 218 up to maximum priority (e.g., 100) for an object 218 that is stationary.

Moreover, the computer 104 may assign priorities to objects 218 based on relative trajectories 220 of the objects 218. That is, as a trajectory 220 passes closer to the vehicle 102 for longer distances, the computer 104 may correspondingly raise the priority of the object 218 having that trajectory 220. As an example, an object 218 travelling away from the vehicle 102 on a trajectory 220 at a speed greater than 15 mph may have the baseline priority (e.g., 1). An object 218 on a trajectory 220 parallel to the vehicle 102 trajectory may have a priority of 50. And the computer 104 may increase the priority of the object 218 by a specified linear amount up to the maximum (e.g., 100) which is assigned when the trajectory 220 is travelling directly towards the vehicle 102 on the shortest possible axis.

### Example Processes

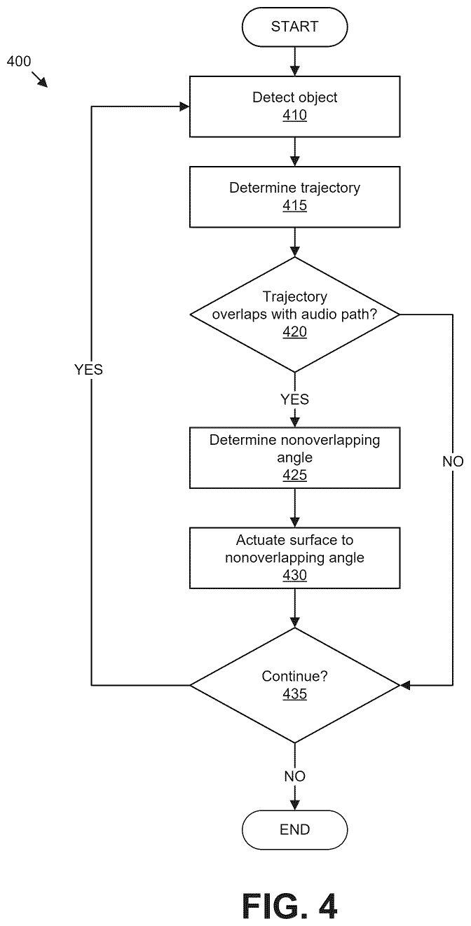

FIG. 4 is a flowchart illustrating an example process 400 for actuating a moveable platform 202 based on trajectories 220 of objects 218. The memory of the computer 104 stores executable instructions for performing the steps of the process 400 and/or programming can be implemented in structures such as mentioned above. As a general overview of the process 400, the computer 104 receives data through the communications network 114, determines the trajectory of the object, determines how to actuate the moveable platform 202, and actuates the moveable platform 202 based on the determination of the trajectory 220. The process 400 may continue for as long as the vehicle 102 remains on.

The process 400 begins in a block 410, in which the computer 104 detects one or more objects 218 based on data received from the sensors 106 as described above.

Next, in a block 415, the computer 104 determines the trajectories 220 of the one or more objects 218 as described above.

Next, in a decision block 420, the computer determines whether the trajectories 220 overlap with the axis 212 of the sound output zone 214 as described above. If no trajectory 220 will overlap with the sound output zone 214, the process continues to a block 460. Otherwise, the process continues to a block 425.

In the block 425, the computer 104 determines how to actuate the moveable platform 202 so as to direct the sound output zone 214 away from the objects 218 while still passing through the vehicle occupant, or to maximize the length of time when the sound output zone 214 will intersect the vehicle occupant while not passing through the object 218 as described above. The computer 104 may utilize process 500 to determine how to actuate the moveable platform. Process 500 is described in further detail below.

Next, in a block 430, the computer 104 actuates the moveable platform 202 as determined in the previous block 425 and as described above.

Next, in the block 435, the computer 104 determines whether to continue the process 400. For example, the computer 104 may determine whether the vehicle 102 is still on. In response to the vehicle 102 still being on, the process 400 returns to the block 415 to continue detecting objects 218. In response to the vehicle 102 turning off, the process 400 ends.

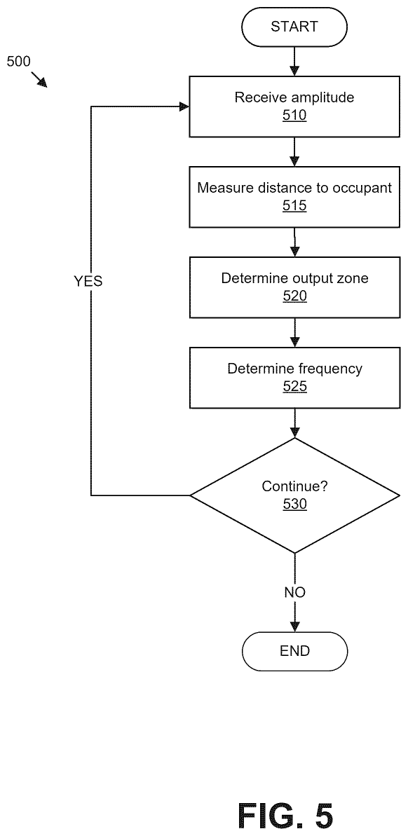

FIG. 5 is a flowchart illustrating an example process 500 for determining the audio output zone 214 as well as angles between link members 204, 206 and the moveable platform 202. The memory of the computer 104 stores executable instructions for performing the steps of the process 500 and/or programming can be implemented in structures such as mentioned above. The process 500 may occur prior to step 420 of the process 400.

The process begins in a block 510, in which the computer 104 receives an amplitude of the sound to be output by the speaker 110. That is, the user specifies a volume of the sound as described above.

Next, in a block 515, the computer 104 measures the distance between the vehicle occupant and the speaker 110. The computer 104 may measure the distance via sensor data such as image data or radar data.

Next, in a block 520, the computer 104 determines the sound output zone 214 based on the desired amplitude (e.g., the volume selected by the user) in the block 510 and the distance between the occupant and the speaker 110 measured in the block 515 as described above (e.g., a sound output zone 214 within which the sound output 214 ceases propagation at a specified distance behind the head 216 of the occupant while still being audible to the occupant). The computer 104 may calculate sound output zones 214 which would result from different variables and select the sound output zone 214 which conforms with stored specifications. For example, the computer 104 may measure a radius of the sound output zone 214 in a plane tangential to the axis 212 where the axis 212 intersects the occupant (e.g., the computer 104 may measure the radius of the cone which is the sound output zone 214 at the point where the cone meets the occupant). The computer 104 may store specifications that the output zone 214 must propagate out to a 10 centimeter radius of the point at which the axis 212 intersects the face of the occupant. Accordingly, the computer 104 determines the dimensions of the sound output zone 214.

Next, in a block 525, the computer 104 determines the frequency of sound waves which will result in the sound propagating within, but not beyond, a specified three-dimensional space (e.g., the sound output zone 214) based on the amplitude of the sound waves and the distance of the vehicle occupant from the speaker 110. The computer 104 may utilize computations such as, for example, Equation 1 to compute the distances that the sound will propagate. The specified space may, for example, be a space which ceases no more than 10 centimeters behind a head 216 of the vehicle occupant.

Next, in the block 530, the computer 104 determines whether to continue the process 500. For example, the computer 104 may determine whether the vehicle 102 is still on. In response to the vehicle 102 still being on, the process 500 returns to the block 510 to continue awaiting a received amplitude. In response to the vehicle 102 turning off, the process 500 ends.

Computing devices such as those discussed herein generally each includes commands executable by one or more computing devices such as those identified above, and for carrying out blocks or steps of processes described above. For example, process blocks discussed above may be embodied as computer executable commands.

Computer executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands (i.e., from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer 104 (i.e., by a processor of a computer 104). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer 104. Common forms of computer-readable media include, for example, RAM, a PROM, an EPROM, a FLASH-EEPROM, any other memory chip or cartridge, or any other medium from which a computer 104 can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Use of in response to, based on, and upon determining herein indicates a causal relationship, not merely a temporal relationship. “Based on” or “in response to” can mean based at least partly on or at least partly in response to unless explicitly stated otherwise.

Examples are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the Figures should not be viewed as limiting. It should be understood that other embodiments might include more or less of each element shown in a given Figure. Additionally, some of the illustrated elements may be combined or omitted. Yet further, an example embodiment may include elements that are not illustrated in the Figures.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described. The adjectives “first” and “second” are used throughout this document as identifiers and are not intended to signify importance, order, or quantity. Use of “in response to,” “upon determining,” etc. indicates a causal relationship, not merely a temporal relationship. Operations, systems, and methods described herein should always be implemented and/or performed in accordance with an applicable user's manual and/or guidelines.

1. A system comprising a computer having a processor and a memory, the memory storing instructions executable by the processor to:
output ultrasonic audio from a speaker that is supported by a moveable surface mounted in an interior of a vehicle;
detect an object within a threshold distance of the vehicle;
determine a trajectory of the object; and
based on the trajectory of the object, actuate the moveable surface to direct the ultrasonic audio based on the trajectory of the object.

2. The system of claim 1, wherein actuating the moveable surface includes directing an axis of the ultrasonic audio away from the trajectory of the object.

3. The system of claim 1, wherein the ultrasonic audio includes a first sound output having a first frequency and a second sound output having a second frequency, the first sound output and second sound output producing a third sound output having a third frequency.

4. The system of claim 1, wherein the moveable surface is a first link member supported by a second link member, the speaker being supported by the first link member.

5. The system of claim 1, wherein the moveable surface is supported by a rear-view mirror.

6. The system of claim 1, the instructions including further instructions to, based on detecting a second object, assign respective priorities to the object and the second object.

7. The system of claim 6, the instructions including further instructions to actuate the moveable surface to direct a direction of the ultrasonic audio away from the trajectory of the object having a highest priority.

8. The system of claim 6, the instructions including further instructions to actuate the moveable surface to direct a direction of the ultrasonic audio away from the trajectory of all objects.

9. The system of claim 6, wherein the priorities are assigned based on relative proximity to the vehicle.

10. The system of claim 6, wherein the priorities are assigned based on relative speeds of the objects.

11. The system of claim 6, wherein the priorities are assigned based on relative trajectories of the objects.

12. A method comprising:
outputting ultrasonic audio from a speaker that is supported by a moveable surface mounted in an interior of a vehicle;
detecting an object within a threshold distance of the vehicle;
determining a trajectory of the object; and
based on the trajectory of the object, actuating the moveable surface to direct the ultrasonic audio based on the trajectory of the object.

13. The method of claim 12, wherein actuating the moveable surface includes directing an axis of the ultrasonic audio away from the trajectory of the object.

14. The method of claim 12, wherein the ultrasonic audio includes a first sound output having a first frequency and a second sound output having a second frequency, the first sound output and second sound output interfering to produce a third sound output having a third frequency.

15. The method of claim 12, further comprising, based on detecting a second object, assigning respective priorities to the object and the second object.

16. The method of claim 15, further comprising actuating the moveable surface to direct a direction of the ultrasonic audio away from the trajectory of the object having a highest priority.

17. The method of claim 15, further comprising actuating the moveable surface to direct a direction of the ultrasonic audio away from the trajectory of all objects.

18. The method of claim 15, wherein the priorities are assigned based on relative proximity to the vehicle.

19. The method of claim 15, wherein the priorities are assigned based on relative speeds of the objects.

20. The method of claim 15, wherein the priorities are assigned based on relative trajectories of the objects.
